(19) United States
(12) Patent Application Publication
(10) Pub. No.: US 2009/0273529 A1
(43) Pub. Date: Nov. 5, 2009

(54) MULTIPLE ANTENNA ARRANGEMENT

(75) Inventor: Zidong Liu, Poole (GB)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/440,983

(22) PCT Filed: Sep. 10, 2007
(86) PCT No.: PCT/IB2007/053646

§ 371 Date: Mar. 12, 2009

(30) Foreign Application Priority Data
Sep. 12, 2006 (EP) 06120534.0

(51) Int. Cl. H01Q 21/00; H01Q 9/04; H01Q 13/10

(52) U.S. Cl. 343/725; 343/700 MS

(57) ABSTRACT

An antenna arrangement having a ground plane (30, 212) a PIFA antenna (15, 240) arranged parallel to the ground plane, and a quarter wave slot antenna (220), arranged to radiate or receive with orthogonal polarisations, the ground plane being rectangular and having higher and lower E field regions (25), caused by use of either of the antennas. The feed (205, 218) of at least one of the antennas is located in the lower E field region caused by the other of the antennas, to provide improved isolation for a compact size. This can be useful for diversity or dual band use, for mobile handset devices.

### TECHNICAL FIELD

This invention relates to antenna arrangements and to devices having such antenna arrangements.

### BACKGROUND ART

Modern mobile phone handsets and other portable devices typically incorporate an internal antenna, such as a Planar Inverted-F Antenna (PIFA) or other planar antenna, or similar. Planar inverted F-antennas in mobile terminals are used to cover an increasing number of communications bands, such as CDMA850, GSM900, GSM1800, PCS1900, and UMTS2000. At the same time, the size of mobile terminals has been reduced dramatically. The miniaturisation of mobile terminals leaves ever less space for the antenna. However, there are the fundamental limits on bandwidth as a function of antenna volume. Generally speaking, the smaller the antenna size, the narrower the bandwidth.

In addition, modern handheld devices are required to cover an increasing number of communications systems. Therefore, more than one antenna has been or will be introduced into handheld devices, for example cellular antenna, Bluetooth antenna, mobile TV antenna, and WLAN antenna. To minimise the interference among the antennas, the antennas need to be positioned as far as possible from each other. However, the size of mobile terminals has been reduced dramatically. The miniaturisation of mobile terminals leaves ever less space for the antennas.

Antenna diversity is a well-known technique for mitigating the effects of multipath propagation in a wireless system. In general there are three types of antenna diversity techniques; pattern diversity, space diversity, and polarisation diversity. In all types, a receiver receives and combines input from two or more antennas. The antennas are “diverse” in that they are separated by a certain distance and/or have different polarisations or patterns.

However, many issues are associated with adoption of diversity antennas inside handheld devices. One is that the volume of diversity antennas is too large for modern compact handheld devices to achieve a high isolation and low cross-correlation coefficient, particularly in the GSM900/800 bands. An example of using polarisation diversity in antennas for lap top computers is shown in U.S. Pat. No. 6,518,929. This shows a single-plane antenna structure that provides the two separate polarisations needed for signal isolation. Polarisation separation is achieved using one antenna that is an electric field structure, such as a monopole antenna, adjacent to an antenna that is a magnetic field structure, such as a slot or loop antenna. The loop antenna will propagate primarily perpendicular to the plane of the loop, while the monopole antenna will propagate primarily parallel to the plane of the monopole. When the two different kinds of structures are placed in the same plane, the polarisations are orthogonal and provide the desired signal isolation.

In “A compact planar polarisation diversity antenna for mobile communication” by Yu, Wang and Wu, p 682-685, 0-7803-7846-6/6/03, IEEE, it is reported that the development of a diversity antenna for modern compact handsets is a significant challenge due to the conflicting requirements imposed on the antenna, such as compactness, bandwidth, efficiency, and isolation between the feed ports. This document proposes a cross-shaped patch antenna to provide polarisation diversity, with the length of the branches reduced by using capacitive loads. Slots are provided in the branches to improve isolation.

It is also known from “An integration version for polarisation diversity of microstrip patch antennas” by Cheng, Nie and Wu, p 479-482, 0-7803-8883-6/05, IEEE, to try different arrangements of pairs of microstrip patch antennas with polarisation diversity for mobile terminal applications, including co-planar and back to back arrangements of the patches. The coupling and correlative coefficients were found to depend on distance and substrate type as well as polarisation directions.

### DISCLOSURE OF INVENTION

An object of the invention is to provide improved apparatus or methods.

According to a first aspect of the invention there is provided an antenna arrangement having a ground plane, a planar antenna, and a slot antenna in the form of a slot in the ground plane, the planar antenna and the slot antenna being arranged to radiate or receive with different polarisations, the ground plane having higher and lower E field regions, caused by use of either of the antennas, and a feed of at least one of the antennas being located in the lower E field region caused by the other of the antennas.

This combination of different types of antenna can provide relatively well defined lower E field regions in a relatively compact size. This means that proper location of either or both feeds to the antennas can provide improved isolation or other effects for example. This can be useful whether the different antennas are used for diversity or dual band use or other purposes. Any additional features can be added to these features. Some such additional features are shown as part of the embodiments described below. Any of the additional features can be combined together and combined with any of the aspects. Other advantages will be apparent to those skilled in the art, especially over other prior art. Numerous variations and modifications can be made without departing from the claims of the present invention. Therefore, it should be clearly understood that the form of the present invention is illustrative only and is not intended to limit the scope of the present invention.

### BRIEF DESCRIPTION OF DRAWINGS

How the present invention may be put into effect will now be described by way of example with reference to the appended drawings, in which:

FIG. 1 shows a schematic view of a mobile handset device according to an embodiment of the invention;

FIG. 2 shows a schematic view of compact multiple antennas, according to an embodiment of the invention;

FIGS. 3a and 3b show the E-field distributions of the PIFA and slot antenna of FIG. 2 at 940 MHz;

FIG. 4 is a graph of simulated input return loss (S11) of the PIFA and slot antenna for the multiple antennas of FIG. 2;

FIG. 5 is a graph of simulated coupling (S21) for the multiple antennas of FIG. 2;

FIG. 6 shows an embodiment of a device having the diversity antennas; and

FIG. 7 shows another embodiment.

### MODES FOR CARRYING OUT THE INVENTION

In at least some of the embodiments of this invention, two antennas have been built into a handheld device; a planar antenna and a quarter-wavelength slot antenna. The feed of the slot antenna is placed in a lower E field region, such as on a minimum E-field line excited by the planar antenna. The open end of the slot is pointed away from the planar antenna so that the feed of the planar antenna is located at the lower E-field area of the slot antenna. The polarisation of the slot antenna is different by being orthogonal or nearly orthogonal, to that of the planar antenna, so as to create some isolation, for example greater than 15 dB.

Polarisation diversity can be achieved in principle by using a half-wavelength antenna (or two half-wavelength antennas) or two quarter-wavelength antennas. The former solution is too big for modern hand-held devices, but with the latter solution it is difficult to achieve a good isolation in practice (for example greater than 15 dB), while maintaining sufficient bandwidth and efficiency. Recognising that for a patch antenna, a high isolation and a low correlation coefficient between two feeds can be achieved when one of two feeds is located at the minimum E-field line of another, and vice versa, (M. J. Cryan, Ps. S. Hall, S. H. Tsang, and J. Sha, IEEE Trans. Microwave Theory Technol., vol. 45, pp. 1742-1748, October 1997), it has now been found that by using an arrangement of the planar antenna and the slot antenna, there are particularly low E field regions even when the antennas are close together. As a result, these two antennas can be placed in closer proximity and also give low cross-correlation coefficient and a high isolation. In other words, high isolation and low cross-correlation coefficient between two antennas can be achieved by placing the feed of one of the antennas on a lower E-field area caused by the other of the antennas.

Additional features can include the antennas being arranged to operate as a diversity arrangement. The isolation between antennas is equally useful if the different antennas are used for different bands instead. Other additional features are the feeds of each of the antennas being located in the lower E field regions caused by the other of the antennas, and the lower E field region caused by the planar antenna being in a central region of the ground plane. This results in the isolation being improved for both antennas. The planar antenna can comprise a PIFA, as this can give good performance in a compact size. The slot antenna can be arranged to have its feed substantially λ/4 away from an edge of the ground plane, the ground plane having a substantially rectangular shape, or having a length or width of substantially λ/2, a length of less than 150 mm, or a width of less than 50 mm. Further additional features are the planar antenna being arranged adjacent a first edge of the ground plane, the slot having an open end at an opposing edge of the ground plane. This tends to make the lower E field region occur at the first edge, and so enable better isolation. The slot antenna can have any one or more of the following; a quarter wave length characteristic, a location adjacent and substantially parallel to an edge of the ground plane, a straight or meandering slot, and a superstrate over the slot. The slot being adjacent an edge is not usually as good a location as in the centre of the ground plane, but in devices with keyboards, or similar, at a central location, the edges of the ground plane can prove to be a better location in practice. Yet further additional features are a transceiver having the antenna arrangement, and the planar antenna being coupled for use as a transmitting and receiving antenna, with the slot antenna being coupled for use only as a receiving antenna for diversity reception. The transceiver can be arranged for use with multiple bands. It can be arranged to transmit or receive any one or more bands used for any one or more of CDMA850, GSM900, GSM1800, PCS1900, UMTS2000, Bluetooth or IEEE 802.11b at 2.4 to 2.5 GHz, TD-SDCMA at 2.3 to 2.4 GHz, or UMTS future expansion at 2.5 to 2.7 GHz, for example. Any of these features can be incorporated in a mobile handheld device of any type.

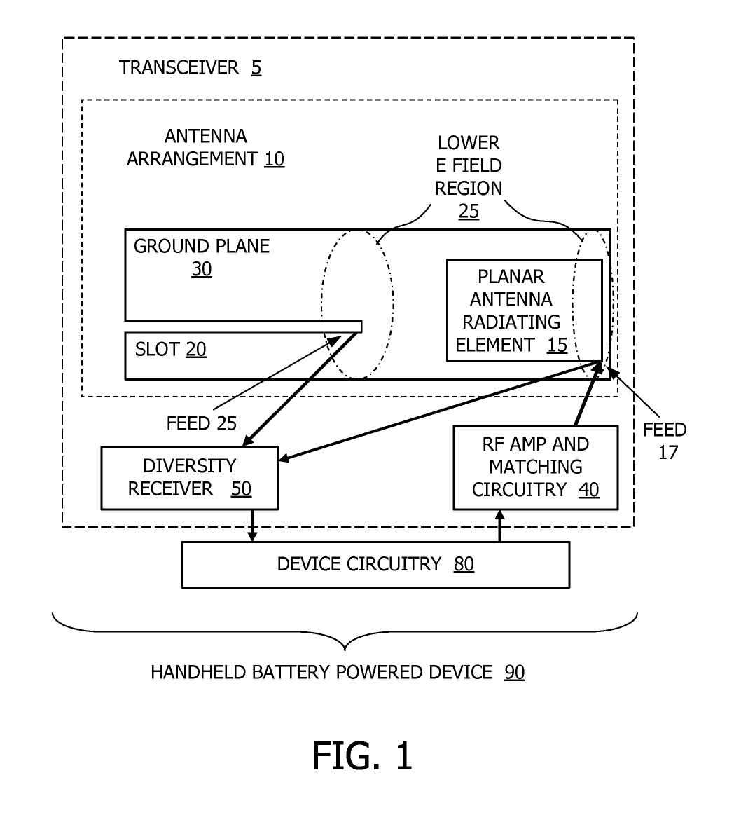

FIG. 1 shows a schematic view of an embodiment of the invention. In this Figure, a mobile handset in the form of a handheld battery powered device 90, has a transceiver 5, which comprises an antenna arrangement 10, a diversity receiver 50 coupled to the antenna arrangement 10, RF amplifier and matching circuitry 40 coupled to the antenna arrangement 10. The device 90 also has device circuitry 80 coupled to the receiver and to the RF amplifier. The antenna arrangement 10 has a ground plane 30, a slot antenna 20 and a planar antenna radiating element 15. The ground plane 30 has a lower E field region 25 near the centre of the ground plane 30, caused by the planar antenna 15, and a lower E field at the right end of the ground plane 30 caused by the slot antenna 20 being located at the left side as shown. A feed 25 of the slot antenna 20, coupling it to the receiver, is shown at the right end of the slot, in the region of lower E field caused by the planar antenna 15. A feed 17 of the planar antenna 15 is shown located at the edge of the planar antenna 15 radiating element, again in a region of lower E-field, this time at the right side of the ground plane 30. This feed 17 couples the radiating element both to the diversity receiver and to the matching circuitry of the RF amp, typically via a switch (not shown).

Any type of receiver circuitry can be used, and typically it will include matching circuitry. The device circuitry 80 can include baseband processing for implementing a protocol stack and application specific circuitry depending on the type of device 90, such as circuitry for a keyboard, a display, storage, power control, and general processing circuitry.

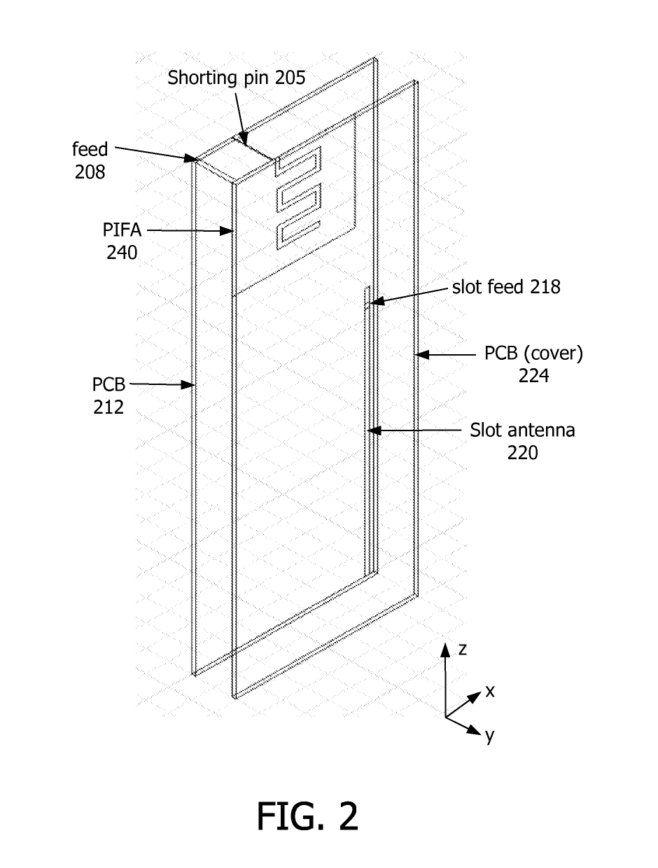

A perspective view of a diversity antenna arrangement according to an embodiment of the invention is shown in FIG. 2. It shows a diversity antenna arrangement comprising a planar antenna in the form of a PIFA 240, and a quarter-wavelength slot antenna 220. In principle any kind of planar antenna can be used, with or without a shorting pin 205 but a PIFA is particularly suitable for mobile handset applications. In principle, the slot antenna 20 could be a half wavelength slot antenna, but at the cost of larger size of the arrangement. The slot antenna 20 has a slot antenna feed 218. The PIFA 240 comprises a ground plane (the bottom PCB 212) having a rectangular shape, and a radiating plate above the ground plane and separated by a dielectric such as air. It is fed via a feed pin 208, and connected to the ground plane by a shorting pin 205. Two resonant frequencies can be created by cutting a slot in a meandering shape as shown in the Figures, or other shape of slot, into the radiating plate. The ground plate is shown parallel to the radiating plate, and as a flat plate, but other orientations and shapes for the ground plane are conceivable, for example it need not be flat, and can be curved to conform to, or fit around, other parts of a mobile handset. In principle the two antennas can have separate ground planes, though this would typically make the arrangement less compact. The radiating plate is shown as being supported on an upper PCB(cover) 224. This is shown extending over the entire area of the lower PCB, though it need not extend beyond the radiating plate of the PIFA 240.

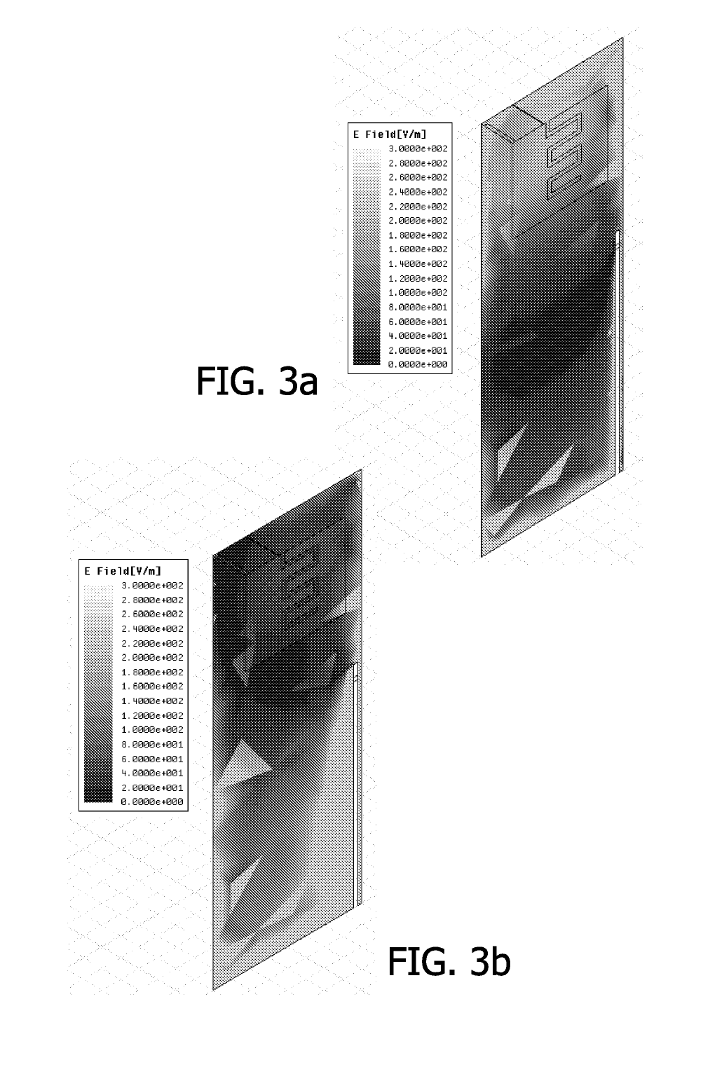

The polarisation of the PIFA 240 is closely aligned with the Z-axis, in other words parallel to the plane of the ground plane. In principle the planar antenna could be in other positions and could be rotated while still providing polarisation along the Z-axis, since the polarisation is determined by the longer dimension of the ground plane. Similarly, the slot antenna 220 can be moved to other locations such as the centre of the ground plane, provided it is still aligned along the Z-axis to provide polarisation along the x-axis to be orthogonal to the polarisation of the planar antenna. The E-field distribution of the PIFA 240 at 940 MHz is shown in FIG. 3a. The shading indicates the strength of the E-field, with the dark areas corresponding to a lower E-field strength. It clearly shows the position of the lower E-field region on the ground plane on the bottom PCB 212. The quarter-wavelength slot antenna is fed at any position of low E field, and preferably on a minimum E-field line excited by the PIFA 240. The E-field distribution of the slot antenna 220 at 940 MHz is shown in FIG. 3b. The E-field is very weak (dark region) at the top edge, and so the PIFA feed can be in various positions near this edge. The dimensions of the ground plane can be significant, as well as the locations of the antennas, in determining regions of lower or higher E field. If a length or width of the ground plane is substantially λ/2, or less, this will help to define higher and lower E-field regions. For a 900 MHz band, this means the length of the ground plane should be less than about 150 mm. For higher frequencies, such as 2 GHz, this length should be less than about 70 mm. A rectangular shape as shown makes use of the available area in a typical mobile handset, but other shapes, or other proportions of length and width can be used. The width can be narrower than shown.

The slot antenna 220 is located at the edge of the PCB 212 to minimise the potential interference from the mobile handset keyboard. The polarisation of the slot antenna is aligned with the X-axis, which is orthogonal to that of the PIFA 240. The shape of the slot of the PIFA 240 could be straight, meander, or any other shapes. In order to reduce length of the slot antenna 220 and at the same time maintain its operating frequency, the slot could be covered with a thin layer of a superstrate.

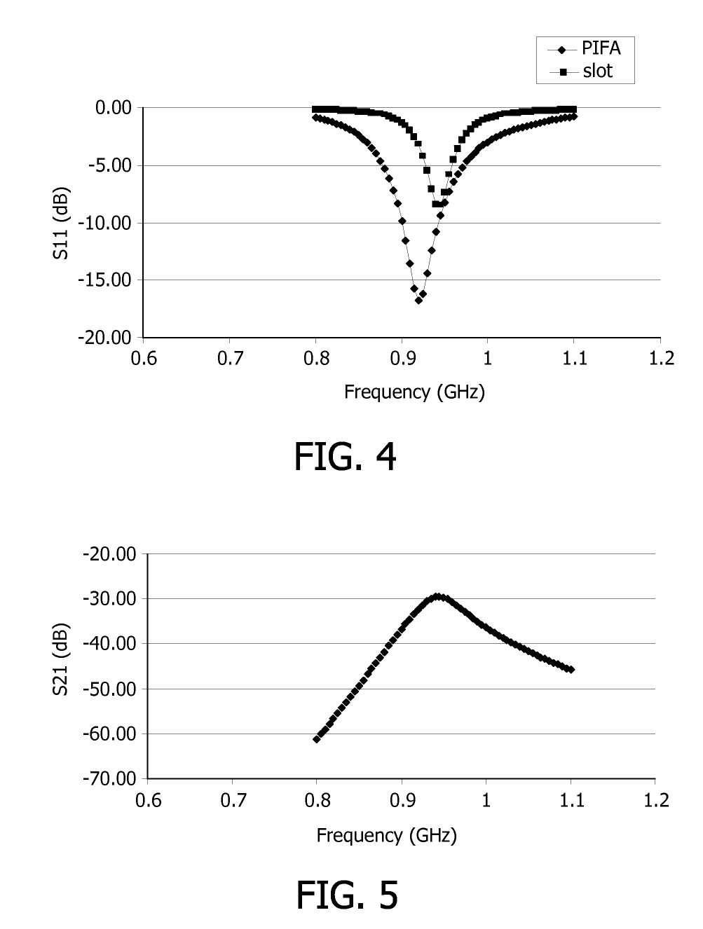

FIG. 4 shows a graph of the S11 parameter of the diversity antenna, and both antennas operate in the GSM900 band. Less than 0.1 of envelope cross-correlation coefficient (ρₑ) and more than 29 dB of isolation has been achieved, as shown by the graph of S21 in FIG. 5.

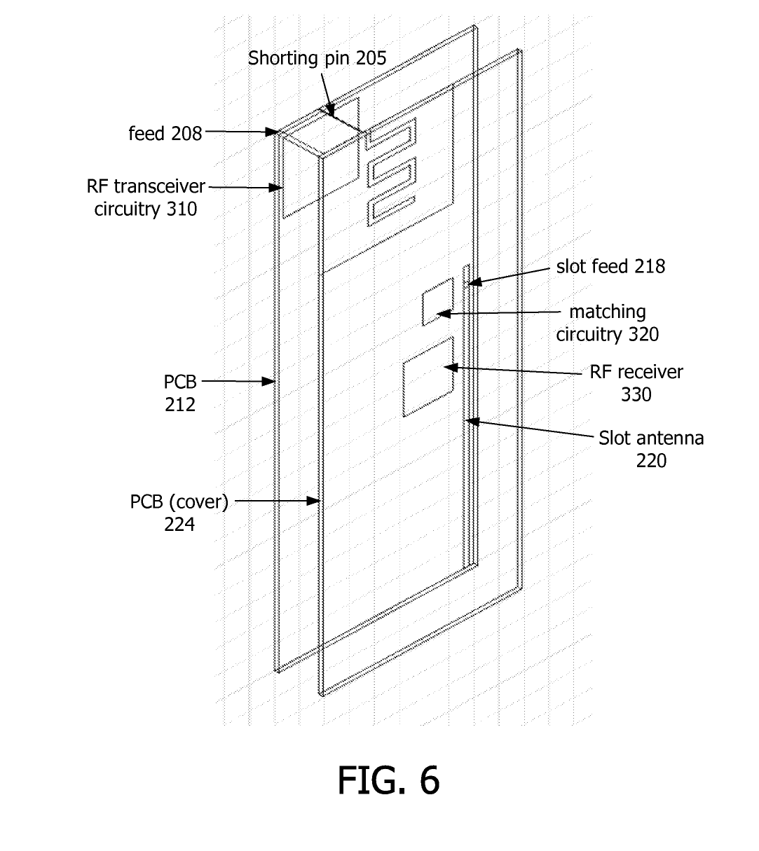

A top PCB cover 224 is shown in FIGS. 2 and 6 as a representation of the case and other parts of the mobile handset, which makes a useful approximation for simulation purposes. In practice, the top PCB would be smaller but could be used to carry some components. The dielectric constant and the thickness of both PCB boards are 4.4 and 0.8 mm. The PCB dimensions are 40 mm×100 mm. Other values can be used. The bottom PCB 212 provides a feed signal to the antenna and also forms a ground plane at its back. The performance of the antenna can be simulated using HFSS from Ansoft.

FIG. 6 shows a handheld device according to an embodiment of the invention. Similar reference numerals are used as those in FIG. 2 as appropriate. In addition, this figure shows RF transceiver circuitry 310 coupled to and located close to the PIFA feed 208. Locating close to the feed 208 is not essential but can be helpful for improving RF characteristics. Matching circuitry 320 and RF receiver circuitry 330 is shown located on the lower PCB 212 and close to the slot antenna feed 218. The PIFA is used as a transmitting and receiving antenna operating in the GSM band or multibands. The slot antenna 220 is used only as a receiving antenna for the diversity reception in the GSM band or multibands. The matching circuitry 320 is used to match the slot antenna 220 to a low noise amplifier to achieve a good signal to noise ratio. The antennas of the embodiments can be relatively compact, because the two antennas can be placed in close proximity and yet give low cross-correlation coefficient and a high isolation. The antenna can be applied to any compact wireless devices such as mobile phones, or other handheld devices, or lap top computers for example.

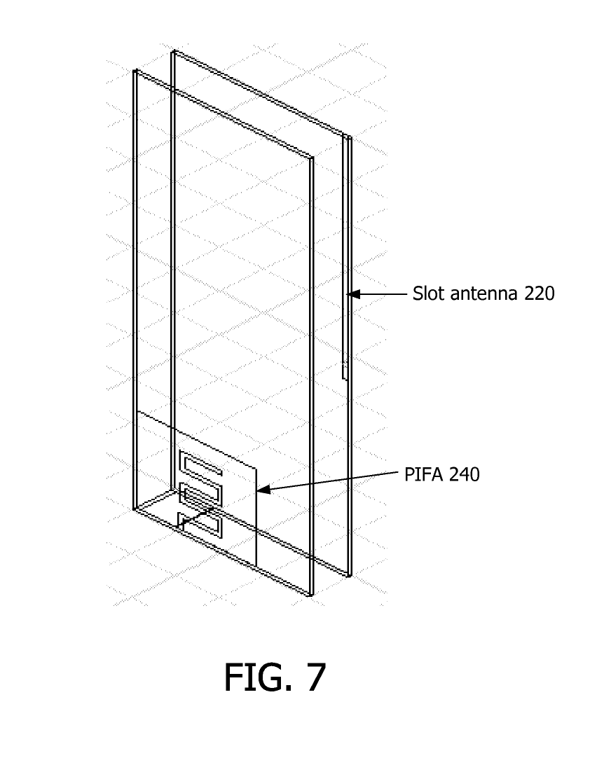

FIG. 7 shows another embodiment with the antennas in alternative positions. The PIFA 240 is at the bottom left and the slot antenna 220 at the top right of the PCB. Other parts correspond to those shown in FIG. 2.

As described above, some embodiments have two antennas built into a handheld device, a planar antenna and a quarter-wavelength slot antenna. The feed of the slot antenna is placed in a lower E field region excited by the planar antenna, such as on a minimum E-field line. The open end of the slot can be pointed away from the planar antenna so that the feed of the planar antenna is located at the lower E-field area of the slot antenna. The polarisation of the slot antenna is orthogonal to that of the planar antenna.

In the present specification and claims the word “a” or “an” preceding an element does not exclude the presence of a plurality of such elements. Further, the word “comprising” does not exclude the presence of other elements or steps than those listed.

From reading the present disclosure, other modifications will be apparent to persons skilled in the art. Such modifications may involve other features which are already known in the design, manufacture and use of planar antennas and component parts therefor and which may be used instead of or in addition to features already described herein.

1. An antenna arrangement having a ground plane, a planar antenna, and a slot antenna in the form of a slot in the ground plane, the planar antenna and the slot antenna being arranged to radiate or receive with different polarisations, the ground plane being of suitable dimensions to have higher and lower E field regions, caused by use of either of the antennas, and a feed of at least one of the antennas being located in the lower E field region caused by the other of the antennas.

2. The antenna arrangement of claim 1, the feeds of each of the antennas being located in the lower E field regions caused by the other of the antennas.

3. The antenna arrangement of claim 1, the lower E field region caused by the planar antenna being in a central region of the ground plane.

4. The antenna arrangement of claim 1, the slot antenna being arranged to have its feed substantially λ/4 away from an edge of the ground plane.

5. The antenna arrangement of claim 1, the ground plane having any one or more of the following: a substantially rectangular shape, a length or width of substantially λ/2, a length of less than 150 mm, a width of less than 50 mm.

6. The antenna arrangement of claim 1, the planar antenna being arranged adjacent a first edge of the ground plane, and the slot having an open end at an opposing edge of the ground plane.

7. The antenna arrangement of any preceding claim, the planar antenna comprising a PIFA.

8. The antenna arrangement of claim 1, the slot antenna having any one or more of the following; a quarter wave length characteristic, a location adjacent and substantially parallel to an edge of the ground plane, a straight or meandering slot, a superstrate over the slot.

9. A transceiver having the antenna arrangement of claim 1, the transceiver being arranged to use the antennas as a diversity arrangement.

10. The transceiver of claim 9, the planar antenna being coupled for use as a transmitting and receiving antenna, with the slot antenna being coupled for use only as a receiving antenna for diversity reception.

11. The transceiver of claim 9 and arranged for use with multiple bands.

12. The transceiver of any of claim 9 and arranged to transmit or receive any one or more bands used for any one or more of CDMA850, GSM900, GSM1800, PCS1900, UMTS2000, Bluetooth or IEEE 802.1 lb at 2.4 to 2.5 GHz, TD-SDCMA at 2.3 to 2.4 GHz, or UMTS future expansion at 2.5 to 2.7 GHz.

13. (canceled)
